(19) United States
(12) Patent Application Publication
(10) Pub. No.: US 2016/0121521 A1
(43) Pub. Date: May 5, 2016

(54) Shoe mold structure

(71) Applicant: CHIA-HUNG WU, Taichung City (TW)

(72) Inventor: CHIA-HUNG WU, Taichung City (TW)

(21) Appl. No.: 14/530,769

(22) Filed: Nov. 2, 2014

(51) Int. Cl. B29C 43/36

(52) U.S. Cl. CPC B29C 43/361; B29L 2031/50

(57) ABSTRACT

A shoe mold structure contains: a base, a lower mold, an upper mold, a mold core, and a vertical moving device. The base includes a moving space, the lower mold includes a lower cavity for corresponding to a profile a body of a shoe and includes a through hole, the upper mold includes an upper cavity corresponding to a profile of a sole of the shoe and includes at least one feeding orifice, wherein a connection surface of the lower mold and the upper mold is configured on a connection area of the body and the sole of the shoe. The mold core includes a molding portion and an extension. The vertical moving device is disposed on the base and pushes the extension from the moving space to drive the molding portion to extend out of the lower cavity upwardly or to extend into the lower cavity downwardly.

### FIELD OF THE INVENTION

The present invention relates to a shoe mold structure which removes a shoe out of a mold core easily.

### BACKGROUND OF THE INVENTION

A conventional shoe mold structure is disclosed in TW Publication No. 363515 and contains two side molds, an upper mold covered on the two side molds, and a mold core disposed in the two side molds. However, in an injection molding process, a parting line forms on a connecting surface of the two side molds to influence aesthetics appearance. In addition, the upper mold and the two side molds are removed from the mold core troublesomely as removing a shoe.

The present invention has arisen to mitigate and/or obviate the afore-described disadvantages.

### SUMMARY OF THE INVENTION

The primary object of the present invention is to provide a shoe mold structure which removes a shoe out of a mold core easily.

Another object of the present invention is to provide a shoe mold structure in which a connection surface of a lower mold and an upper mold is configured on a connection area of a body and a sole of a shoe to ease a parting line on a connection area of the body and the sole, thus enhancing aesthetics appearance.

To obtain the above objects, a shoe mold structure provided by the present invention contains: a base, a lower mold, an upper mold, a mold core, and a vertical moving device.

The base includes a moving space.

The lower mold is mounted on the base and includes a lower cavity for corresponding to a profile a body of a shoe, and a through hole defined on the bottom end thereof and communicating with the moving space.

The upper mold is connected with a rear side of the lower mold and includes an upper cavity defined on a bottom end thereof and corresponding to a profile of a sole of the shoe, and at least one feeding orifice formed in the upper cavity and communicating with a top end of the upper mold, wherein a connection surface of the lower mold and the upper mold is configured on a connection area of the body and the sole of the shoe.

The mold core includes a molding portion and an extension, the molding portion is fixed in the lower mold to correspond to the body molded by the lower cavity and the sole molded by the upper cavity, the extension extends to the moving space from a bottom end of the molding portion through the through hole.

The vertical moving device is disposed on the base and pushes the extension of the mold core from the moving space to drive the molding portion of the mold core to extend out of the lower cavity upwardly or to extend into the lower cavity downwardly.

### BRIEF DESCRIPTION OF THE DRAWINGS

FIG. 1 is a perspective view showing the operation of a shoe mold structure according to a preferred embodiment of the present invention.

FIG. 2 is a side plan view showing the operation of the shoe mold structure according to the preferred embodiment of the present invention.

FIG. 3 is a cross sectional view showing the operation of the shoe mold structure according to the preferred embodiment of the present invention.

FIG. 4 is another perspective view showing the operation of the shoe mold structure according to the preferred embodiment of the present invention.

FIG. 5 is another cross sectional view showing the operation of the shoe mold structure according to the preferred embodiment of the present invention.

FIG. 6 is also another cross sectional view showing the operation of the shoe mold structure according to the preferred embodiment of the present invention.

FIG. 7 is still another cross sectional view showing the operation of the shoe mold structure according to the preferred embodiment of the present invention.

### DETAILED DESCRIPTION OF THE PREFERRED EMBODIMENTS

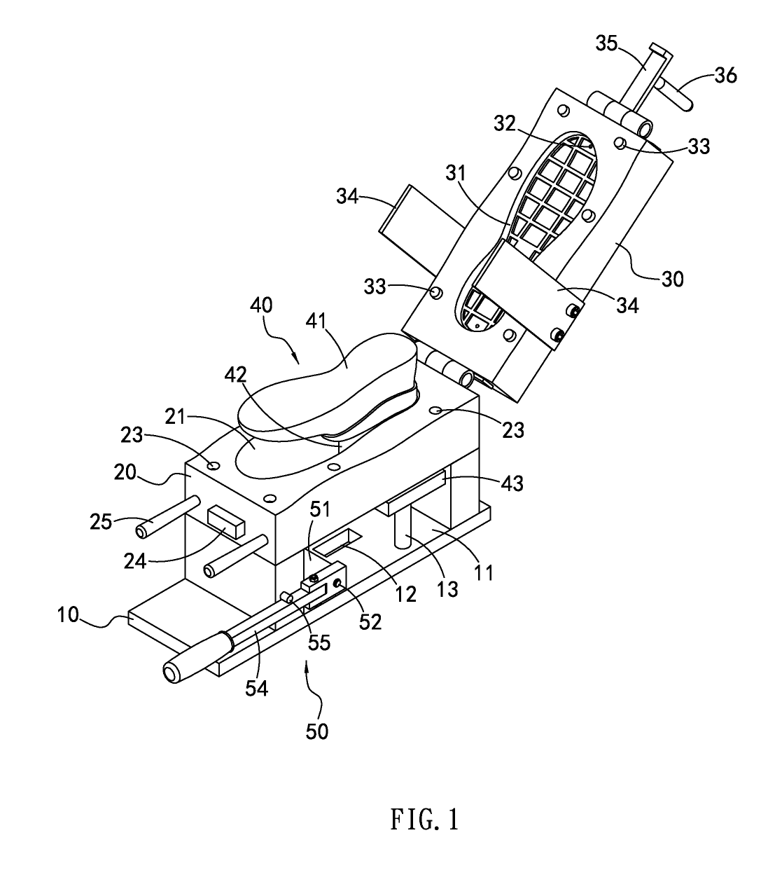

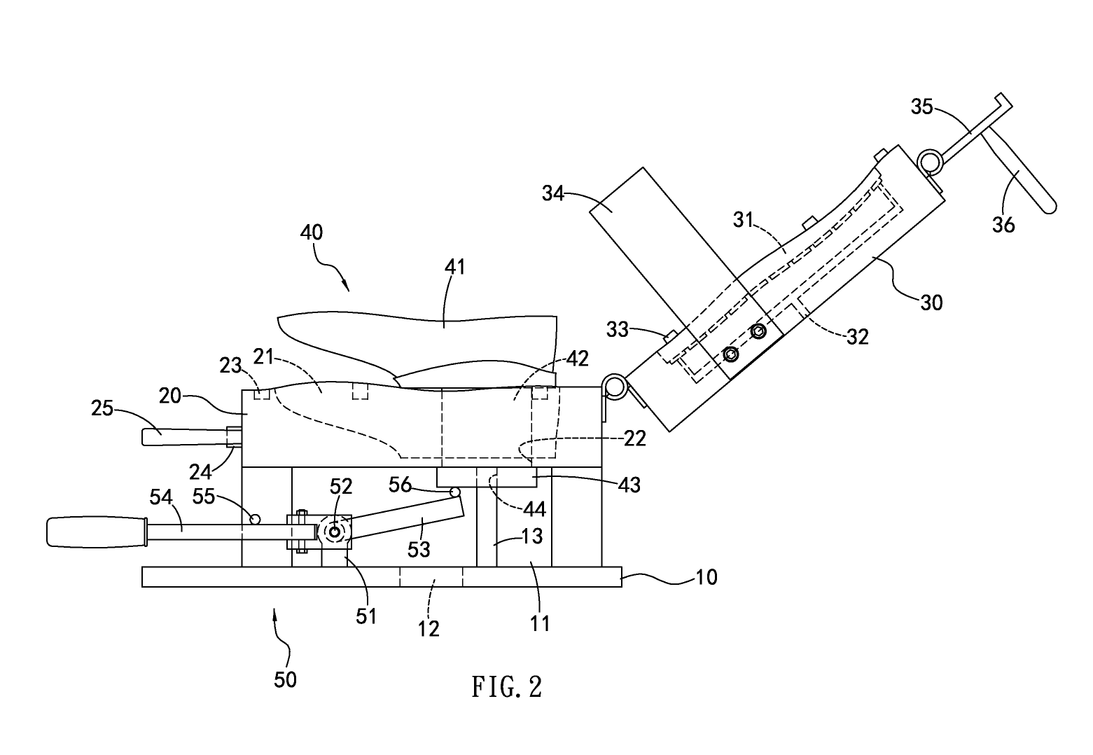

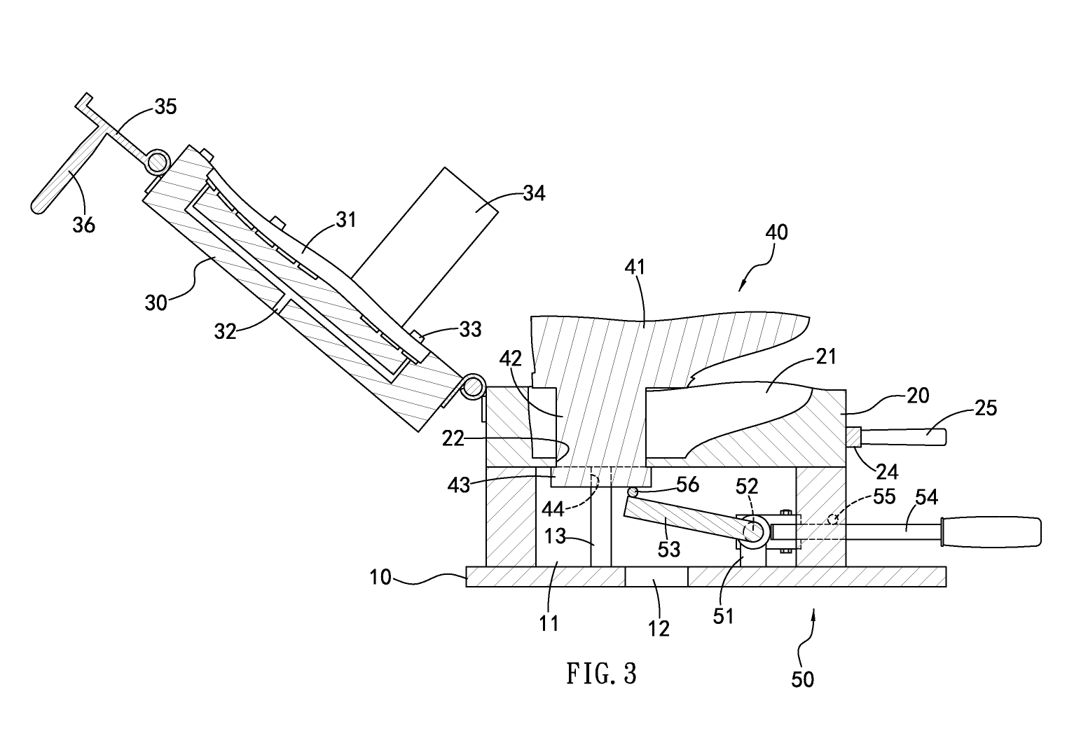

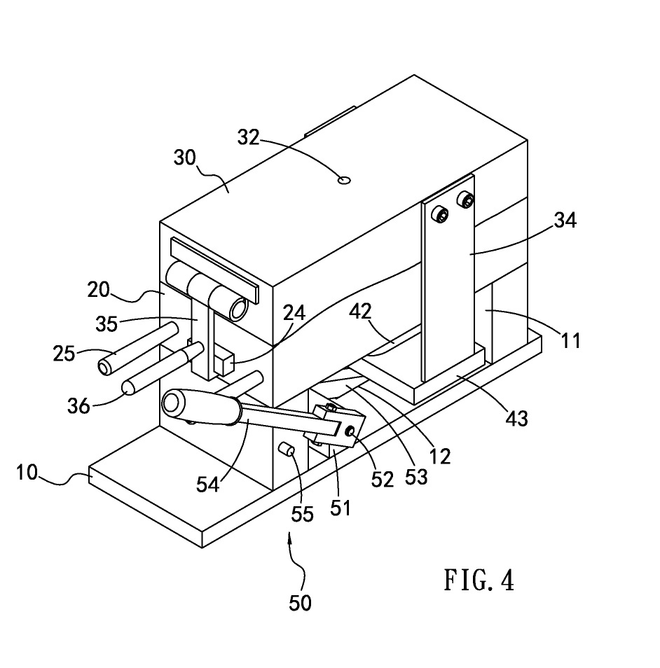

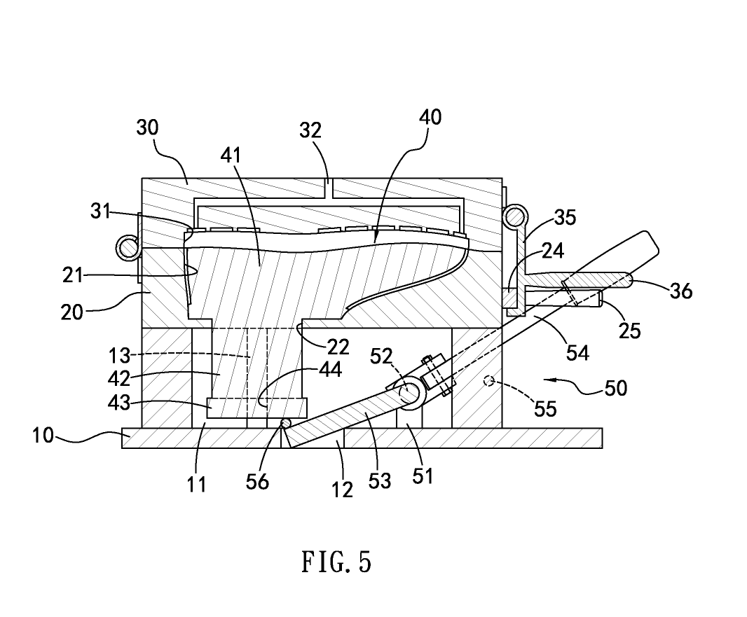

With reference to FIGS. 1 to 5, a shoe mold structure according to a preferred embodiment of the present invention comprises: a base 10, a lower mold 20, an upper mold 30, a mold core 40, and a vertical moving device 50.

The base 10 includes a moving space 11, a recess 12 communicating with the moving space 11, and two guiding levers 13 extending toward a bottom end of the lower mold 20 from the moving space 11.

The lower mold 20 is mounted on the base 10 and includes a lower cavity 21 for corresponding to a profile a body of a shoe, a through hole 22 defined on the bottom end thereof and communicating with the moving space 11, plural positioning grooves 23 formed on a top end thereof, a protrusion 24 mounted on a front surface thereof, and two grips 25 fixed therein beside two sides of the two protrusions 24.

The upper mold 30 is connected with a rear side of the lower mold 20 by ways of a hinge, such that the upper mold 30 is turned over the lower mold 20. The upper mold 30 includes an upper cavity 31 defined on a bottom end thereof and corresponding to a profile of a sole of the shoe, at least one feeding orifice 32 formed in the upper cavity 31 and communicating with a top end of the upper mold 30 to feed injection molding material, a plurality of conical fixing posts 33 arranged on the bottom end thereof, and two limiting plates 34 disposed on two sides thereof, such that when the upper mold 30 is covered on the lower mold 20, the plurality of fixing posts 34 are retained into the plural positioning grooves 23, the two limiting plates 34 abut against two sides of the lower mold 20 to prevent the lower mold 20 and the upper mold 30 from offsetting in an injection molding process. The upper mold 30 also includes a retainer 35 mounted on a front surface thereof to retain with the protrusion 24, thus preventing the lower mold 20 and the upper mold 30 from separating upwardly or downwardly in the injection molding process. The retainer 35 has a handle 36 for being operated by a user to swing the retainer 35.

The mold core 40 includes a molding portion 41, an extension 42, and a holding plate 43. The molding portion 41 is fixed in the lower mold 20 to correspond to the body molded by the lower cavity 21 and the sole molded by the upper cavity 31. The extension 42 extends to the moving space 11 from a bottom end of the molding portion 41 through the through hole 22. The holding plate 43 is movably disposed in the moving space 11 and has a top surface connected with a bottom end of the extension 42. The holding plate 43 has two guide orifices 44 for inserting the two guiding levers 13, such that the holding plate 43 moves vertically in the moving space 43.

The vertical moving device 50 is disposed on the base 10 and includes a seat 51, a coupling stem 52, a push column 53, a control bar 54, and an affixing bolt 55. The seat 51 is mounted in the moving space 11, the coupling stem 52 is rotatably coupled with the seat 51, a first end of the push column 53 is in connection with the coupling stem 52, and a second end of the push column 53 extends to the holding plate 43 and is mounted in the recess 12. The vertical moving device 50 further includes a circular rod 56 fixed on an upper edge thereof and contacting with the holding plate 43, such that the circular rod 56 pushes the holding plate 43 to move upwardly and downwardly. One end of the control bar 54 is connected with the coupling stem 52 so that the control bar 54 is swung upwardly and downwardly to drive the push column 53 to swing along the coupling stem 52, and the coupling stem 52 pushes the holding plate 43 to move upwardly and downwardly, hence the molding portion 41 of the mold core 40 extends out of the lower cavity 21 upwardly or extends into the lower cavity 21 downwardly. The affixing bolt 55 extends beside the base 10, after the control bar 54 swings outwardly and swings downwardly to avoid stopping the affixing bolt 55, such that the mold core 40 moves upwardly to a fixing position and swings inwardly to retain with the affixing bolt 55.

The vertical moving device 50 is a pneumatic cylinders /hydraulic cylinder for driving a vertical movement of the mold core and matches with a rack and a pinion, since the vertical moving device 50 is a well-known prior art, further remarks are omitted.

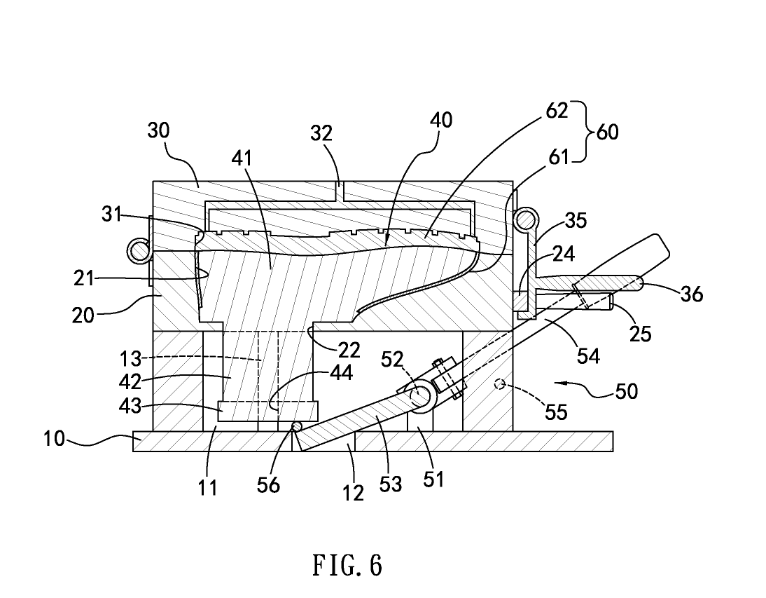

Referring further to FIG. 6, the molding portion 41 of the mold core 40 extends into the lower cavity 21 downwardly by ways of the vertical moving device 50, the upper mold 30 is turned over the lower mold 20, and the retainer 35 is retained with the protrusion 24, such that the injection molding material is fed into the shoe mold structure from the at least feeding orifice 32, and the shoe body 61 of the shoe 60 is molded between the molding portion 41 of the mold core 40 and the lower cavity 21 of the lower mold 20, and the sole 62 of the shoe 60 is molded between the molding portion 41 of the mold core 40 and the upper cavity 31 of the upper mold 30.

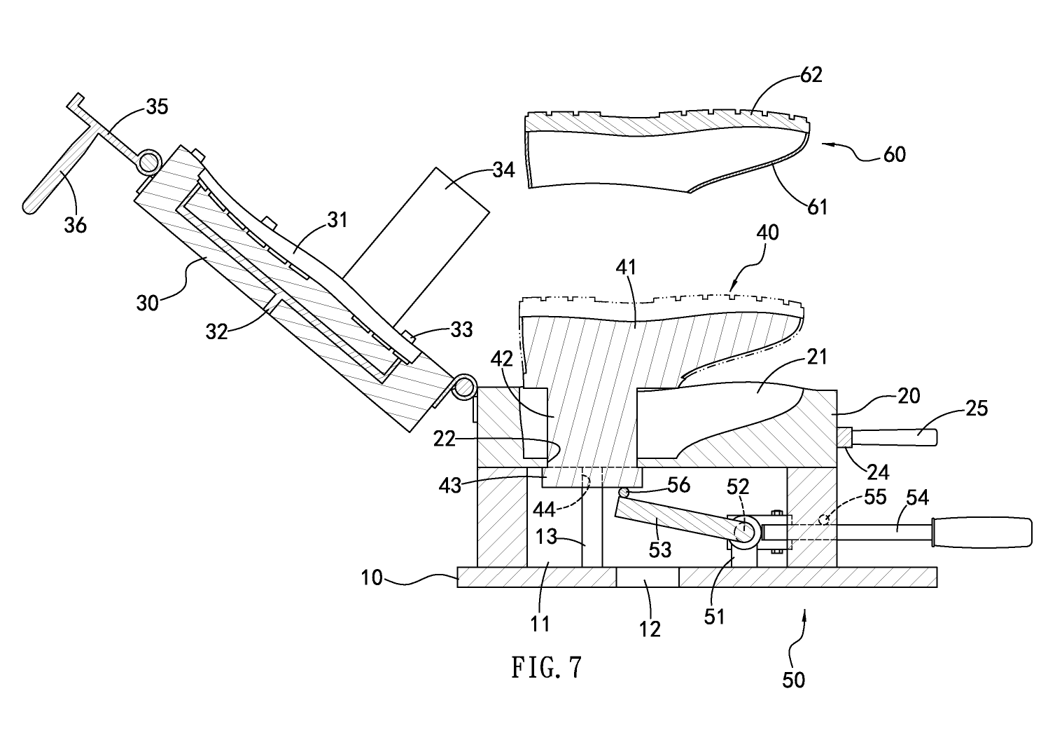

As shown in FIG. 7, when the injection molding material in the lower cavity 21 and the upper cavity 31 is cooled, the retainer 35 is removed from the protrusion 24, and the upper mold 30 is turned upwardly, thereafter the control bar 54 is swung outwardly and downwardly so that the molding portion 41 of the mold core 40 and the shoe 60 are pushed out of the lower cavity 21 upwardly by the push column 53, and the control bar 54 is swung inwardly to retain with the affixing bolt 55 to position the mold core 40, thus removing the shoe 60 out of the mold core 40 easily.

Thereby, the vertical moving device 50 is employed to move the molding portion 41 of the mold core 40 into the lower cavity 21 so that the molding portion 41 corresponds to the lower cavity 21 to mold the body 61 of the shoe 60 and corresponds to the upper mold 31 to mold the sole 62 of the shoe 60 in the injection molding process. Thereafter, the molding portion 14 of the mold core 40 and the shoe 60 are moved out of the lower cavity 21 upwardly by using the vertical moving device 50. Accordingly, a connection surface of the lower mold 20 and the upper mold 30 is configured on a connection area of the body 61 and the sole 62 of the shoe 60 to ease a parting line on the connection area of the body 61 and the sole 62, thus enhancing aesthetics appearance.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A shoe mold structure comprising:
a base including a moving space;
a lower mold mounted on the base and including a lower cavity for corresponding to a profile a body of a shoe, and a through hole defined on the bottom end thereof and communicating with the moving space;
an upper mold connected with a rear side of the lower mold and including an upper cavity defined on a bottom end thereof and corresponding to a profile of a sole of the shoe, and at least one feeding orifice formed in the upper cavity and communicating with a top end of the upper mold, wherein a connection surface of the lower mold and the upper mold is configured on a connection area of the body and the sole of the shoe;
a mold core including a molding portion and an extension, the molding portion being fixed in the lower mold to correspond to the body molded by the lower cavity and the sole molded by the upper cavity, the extension extending to the moving space from a bottom end of the molding portion through the through hole;
a vertical moving device disposed on the base and pushing the extension of the mold core from the moving space to drive the molding portion of the mold core to extend out of the lower cavity upwardly or to extend into the lower cavity downwardly.

2. The shoe mold structure as claimed in claim 1, wherein the base also includes two guiding levers extending toward a bottom end of the lower mold from the moving space, the mold core includes a holding plate movably disposed in the moving space, and the holding plate has two guide orifices for inserting the two guiding levers, such that the holding plate moves vertically in the moving space.

3. The shoe mold structure as claimed in claim 2, wherein the vertical moving device includes a seat, a coupling stem, a push column, and a control bar; the seat is mounted in the moving space of the base, the coupling stem is rotatably coupled with the seat, a first end of the push column is in connection with the coupling stem, and a second end of the push column extends to the holding plate.

4. The shoe mold structure as claimed in claim 3, wherein the vertical moving device also includes an affixing bolt extending beside the base, one end of the control bar is connected with the coupling stem, after the control bar swings outwardly and swings downwardly to avoid stopping the affixing bolt, such that the mold core moves upwardly to a fixing position and swings inwardly to retain with the affixing bolt.

5. The shoe mold structure as claimed in claim 4, wherein the base further includes a recess communicating with the moving space to mount the push column.

6. The shoe mold structure as claimed in claim 4, wherein the vertical moving device further includes a circular rod fixed on an upper edge thereof and contacting with the holding plate.

7. The shoe mold structure as claimed in claim 1, wherein the upper mold further includes two limiting plates disposed on two sides thereof, such that when the upper mold is covered on the lower mold, the two limiting plates abut against two sides of the lower mold.

8. The shoe mold structure as claimed in claim 1, wherein the lower mod further includes plural positioning grooves formed on a top end thereof, a plurality of conical fixing posts arranged on the bottom end thereof, such that when the upper mold is covered on the lower mold, the plurality of fixing posts are retained into the plural positioning grooves.

9. The shoe mold structure as claimed in claim 1, wherein the lower mole further includes a protrusion mounted on a front surface thereof, and the upper mold also includes a retainer mounted on a front surface thereof to retain with the protrusion.

10. The mold structure as claimed in claim 9, wherein the lower mold further includes two grips fixed therein beside two sides of the two protrusions.

11. The shoe mold structure as claimed in claim 1, wherein the vertical moving device is a pneumatic cylinders/hydraulic cylinder for driving a vertical movement of the mold core.
